(19) United States
(12) Patent Application Publication
(10) Pub. No.: US 2026/0047715 A1
(43) Pub. Date: Feb. 19, 2026

(54) FILTERING DEVICE FOR THE EXTRACTION OF A BEVERAGE

(71) Applicant: GIRARDI S.R.L., Spinea (VE) (IT)

(72) Inventor: Marco Flores, Cartigliano (VI) (IT)

(73) Assignee: GIRARDI S.R.L., Spinea (VE) (IT)

(21) Appl. No.: 19/101,207

(22) PCT Filed: Aug. 1, 2023
(86) PCT No.: PCT/IT2023/050187

§ 371 Date: Feb. 4, 2025

(30) Foreign Application Priority Data
Aug. 4, 2022 (IT) 102022000016656

(51) Int. Cl. A47J 31/06; A47J 31/02; A47J 31/44; B01D 29/05; B01D 29/90

(52) U.S. Cl. CPC A47J 31/0626; A47J 31/02; A47J 31/446; B01D 29/05; B01D 29/908

(57) ABSTRACT

Filtering device (10) for the extraction of a beverage (B) through percolation, comprising a tubular body (11) and a support (12) for housing a filter (13) on which a powder product (C) is positioned.

### FIELD OF THE INVENTION

The present invention concerns a filtering device for the extraction of a beverage, in particular by means of percolation. The present filtering device can be used in particular to prepare coffee or other beverages such as tea, herbal teas or other, starting from powder or granular products, or suchlike. The following description will concern in particular the preparation of coffee.

### BACKGROUND OF THE INVENTION

As is known, there are various ways to obtain a coffee beverage from a powder product, that is, by using coffee machines, coffee makers or suchlike, or by means of percolation or infusion by using receptacles and filtering devices.

Extracting coffee through percolation basically consists of pouring hot water on the coffee powder, collecting the beverage in a receptacle below through a filter, which can for example be made of paper, fabric, metal, plastic or other. Using the technique called “pour over”, the hot water uses only the force of gravity to pass through the coffee powder held by the filter.

The infusion of coffee, on the other hand, is obtained by pouring hot water into a receptacle and leaving the ground coffee to soak for a few minutes. After the desired infusion time, the liquid is separated from the ground coffee with the use of a filter, thus obtaining the beverage.

A method for preparing the beverage with a percolation filtration system is known in the state of the art with the name “V60”, which takes its name from the degrees of the angle at the vertex that characterizes both the receptacle as well as the disposable paper filter, both with a conical shape.

This percolation filtration system is substantially instantaneous, that is, the water quickly passes through the coffee powder and comes into contact with it for a very limited period of time. This system therefore does not allow to obtain a beverage with optimal organoleptic properties, since essentially the water does not come into contact with the coffee powder for an amount of time that is sufficient to absorb the organoleptic characteristics of the coffee in a satisfactory manner.

Furthermore, in such a percolation filtration system, considerable skill is required of the user, who has to ensure that the liquid is distributed as homogeneously as possible on the powder product, avoiding both the onset of bypass phenomena, according to which the liquid can pass through the filter in its upper part, in which the powder product is not present, and also channeling phenomena, whereby the liquid enters the powder product with a force such as to define preferential pass through channels, without being homogeneously distributed in the product. It is evident that these phenomena result in a partial and non-homogeneous extraction of the beverage, to the detriment of its quality.

A further mode for preparing coffee by means of percolation is described in document U.S. Pat. No. 7,849,784, in which a filtration device is positioned above a receptacle. This filtration device provides to use a cylinder at the lower end of which, close to the receptacle, there is positioned a filter containing the coffee powder. This lower end is conformed as a lattice on which the filter rests. In this cylinder, above the coffee powder, a certain amount of water is poured, which is thrust through the coffee powder by means of a piston which is able to be inserted from the upper part of the cylinder and is configured to exert a certain pressure on a volume of air sitting above the amount of water.

This system is quite complex and requires different tools for its implementation, such as the cylinder and the piston, for example. Moreover, also in this case, the contact time of the water passing through the coffee powder is rather limited. The user is also required to exert a certain pressure on the piston whenever he wants to prepare a beverage. The presence of the lattice on the one hand is necessary to prevent the pressure of the piston from causing the filter to exit from the cylinder, but on the other hand it constitutes an obstacle to the flow of the beverage, causing an increase in the pressure that the user has to exert on the piston to obtain the extraction of the beverage.

Document WO2007/119546A describes a coffee extractor, substantially comprising two overlapping receptacles, one to supply water located at the top and one to collect the coffee located at the bottom. A filter holder containing the coffee powder is also positioned between the two receptacles, which defines a closed chamber containing the coffee. This conformation causes the closed chamber to inevitably involve the compaction of the coffee powder, forming a block of coffee. This is of course undesirable, since the more compact the powder is, the less a proper and complete extraction of the beverage is likely, which, in order to be achieved, requires the water to be evenly distributed in the chamber and all the coffee powder granules to come into contact with the water for the amount of time necessary to guarantee the extraction of the beverage.

The extractor is rather bulky since, for example, the filter holder is positioned at a certain distance from the water containing receptacle above. The water supply receptacle and the filter holder are separated by a vertical duct, which has a length of several centimeters.

Given its conformation, this extractor, which is made up of many components, is rather laborious to assemble and does not allow an optimal uniformity in the distribution of water on the product contained in the filter holder.

The presence of the vertical water supply duct means that the water reaches the filter holder with differentiated pressure and speed between the center and the zone of the peripheral circular edge. In particular, in the zone directly below the duct, the pressure and speed of the water are very high and result in the formation of holes in the coffee block that define preferential passageways for the water. Through these holes the water flows quickly, without stopping for the amount of time necessary to perform a complete extraction.

Moreover, the extractor provides a paper filter that is supported by a grid, therefore there will be zones below the filter that create resistance to the free passage of the beverage.

The conformation of the extractor described by WO2007/119546 therefore induces the creation of preferential channels for the extraction, therefore the onset of channeling phenomena, in addition to introducing a hydraulic resistance to the advance of the liquid.

Another well-known mode for obtaining coffee beverages provides to use closed capsules, preferably sealed, containing a predetermined dose of coffee powder that hot water passes through when the capsule is placed in a special beverage extraction machine. Examples of this type of capsules are described in prior art documents KR20120114736A and WO2015/124534A.

There is therefore the need to perfect a filtering device for the extraction of a beverage that can overcome at least one of the disadvantages of the state of the art.

In particular, one purpose of the present invention is to provide a filtering device for the extraction of a beverage that is simple to make and use.

Another purpose of the present invention is to provide a filtering device that allows to obtain a slower and gradual extraction of the beverage, compared to known systems, improving its organoleptic properties.

Another purpose of the present invention is to provide a filtering device in which the beverage is substantially obtained by gravity, by means of a suitably slow passage of the water through the coffee powder which is positioned on a filter.

Another purpose of the present invention is to provide a filtering device that allows to obtain a homogeneous extraction of the beverage, ensuring that the liquid wets the coffee powder uniformly.

The Applicant has devised, tested and embodied the present invention to overcome the shortcomings of the state of the art and to obtain these and other purposes and advantages.

### SUMMARY OF THE INVENTION

The present invention is set forth and characterized in the independent claim. The dependent claims describe other characteristics of the present invention or variants to the main inventive idea.

In accordance with the above purposes, a filtering device according to the present invention for the extraction of a beverage comprises a tubular body and a support for housing a filter on which a powder product is positioned, for example coffee powder.

In accordance with some embodiments, the tubular body is open at the upper part. This on the one hand makes it easier to use the filtering device, and on the other means that the powder product can remain disposed in a random manner, as it deposits following the fall, without any compaction of the powder. This is advantageous compared to the solutions known in state of the art in which the powder is received in a closed chamber, which necessarily causes the compaction of the powder, to the detriment of the efficiency of extraction of the beverage.

According to a characteristic aspect of the invention, the filtering device provides a chamber for containing a liquid, in particular hot water, which is external to the tubular body. The chamber is provided with a bottom positioned at a height higher than the height of the filter and it is fluidically connected to the tubular body by means of a plurality of through holes which allow the passage by gravity of the liquid from the chamber to the tubular body and therefore to the powder product. Moreover, the chamber is annular and disposed around the tubular body.

In accordance with some embodiments described here, the annular chamber is open at the upper part.

Thanks to the separation between the liquid containing chamber and the tubular body where the powder product is contained, for example coffee powder, it is advantageously possible to lengthen the amount of time that the liquid, in particular hot water, passes through the powder product, thus obtaining by percolation a beverage with better organoleptic characteristics compared to the beverages obtained with conventional devices.

The present device is also advantageously compact, simple to make and does not require the user to use cylinders, pistons or other.

The annular shape of the chamber also allows a uniform distribution of the extraction beverage all around the filter and therefore around the powder product, further increasing the uniformity of contact with and of passage through the product.

According to another aspect of the invention, the chamber is disposed concentrically around the tubular body. In this way, the hot water penetrates into the coffee powder laterally, favoring the homogeneous extraction of the beverage along the entire circular perimeter.

According to another aspect of the invention, the chamber has a truncated cone shape with a section decreasing from an upper aperture toward the bottom.

According to another aspect of the invention, the bottom is inclined downward toward the tubular body and toward the through holes. This detail allows for example to avoid possible phenomena of stagnation of the liquid.

According to another aspect of the invention, the through holes are uniformly distributed on the tubular body. The through holes can also be directed radially or have a tangential component.

According to another aspect of the invention, the through holes are inclined downward toward the inside of the tubular body.

According to another aspect of the invention, the through holes are positioned in proximity to the bottom of the chamber.

According to another aspect of the invention, the through holes are cylindrical in shape.

According to another aspect of the invention, the through holes have a truncated cone shape and a larger section on the inlet side of the liquid and a smaller section on the outlet side.

These holes can be sized in order to obtain a homogeneous extraction and a beverage which, for the same total dissolved solids (TDS), requires a smaller quantity of powder product, for example coffee powder, compared to the current preparation methods on the market.

According to another aspect of the invention, the tubular body is able to be screwed to the support, integral with the chamber.

According to another aspect of the invention, between the tubular body and the support there are positioned means for holding the filter in position. These means can be for example a labyrinth system, a gasket or other.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a longitudinal section view of a filtering device for the extraction of a beverage according to the present invention disposed on a receptacle for collecting the extracted beverage;

FIG. 2 is a three-dimensional top view of the present filtering device;

FIG. 3 is a three-dimensional bottom view of the present filtering device;

FIG. 4 is a longitudinal section view of a part of the present filtering device provided with a hole for the passage of the liquid;

FIG. 5 is a longitudinal section view of a variant of the hole of FIG. 4;

FIG. 6 is a cross-section view of a tubular body of the present filtering device, considered in correspondence with the through holes for the passage of the liquid;

FIG. 7 is another cross-section view of the tubular body in which a different conformation of said through holes is provided;

FIG. 8 is a longitudinal section view of a variant of the present filtering device;

FIG. 8a is a view like that of FIG. 8, enlarged, of a detail portion of the filtering device of FIG. 8;

FIG. 9 is a longitudinal section view of another variant of the present filtering device;

FIG. 9a is a view like that of FIG. 9, enlarged, of a detail portion of the filtering device of FIG. 9.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

We will now refer in detail to the possible embodiments of the invention, of which one or more examples are shown in the attached drawings, by way of a non-limiting illustration. The phraseology and terminology used here are also for the purposes of giving non-limiting examples.

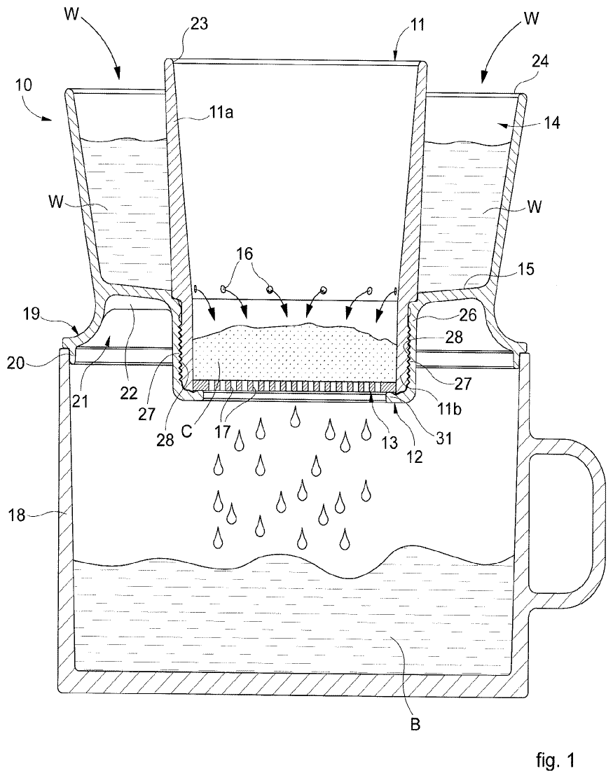

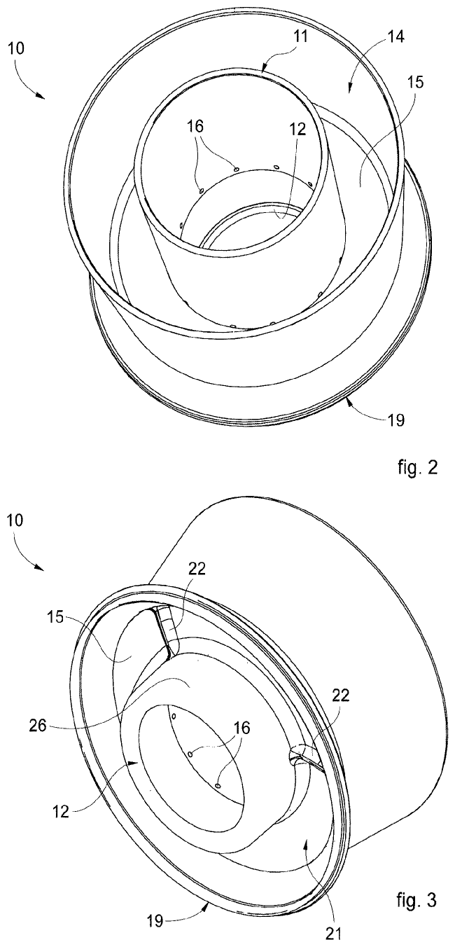

With reference to the attached drawings, see in particular FIGS. 1, 2 and 3, a filtering device 10 for the extraction of a beverage B comprises a tubular body 11 and a support 12 for housing a filter 13 on which there is positioned a powder product C, for example ground coffee, or a preparation for coffee, tea, herbal tea or other. The support 12 is positioned in particular at the lower end of the tubular body 11. The support 12 can for example provide an annular step 31 protruding internally from the lower end of the tubular body 11.

The filtering device 10 provides a chamber 14 for containing a liquid W, in particular hot water, which is outside the tubular body 11. The chamber 14 is provided with a bottom 15 positioned at a height higher than the height of the filter 13 and it is fluidically connected to the tubular body 11 by means of a plurality of through holes 16 that allow the passage by gravity of the liquid W from the chamber 14 to the tubular body 11 and therefore to the powder product C.

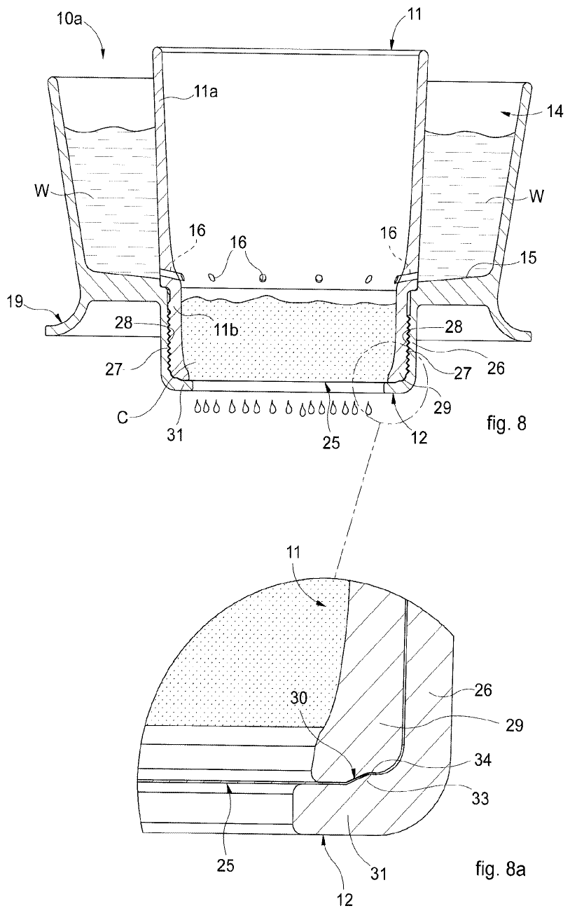

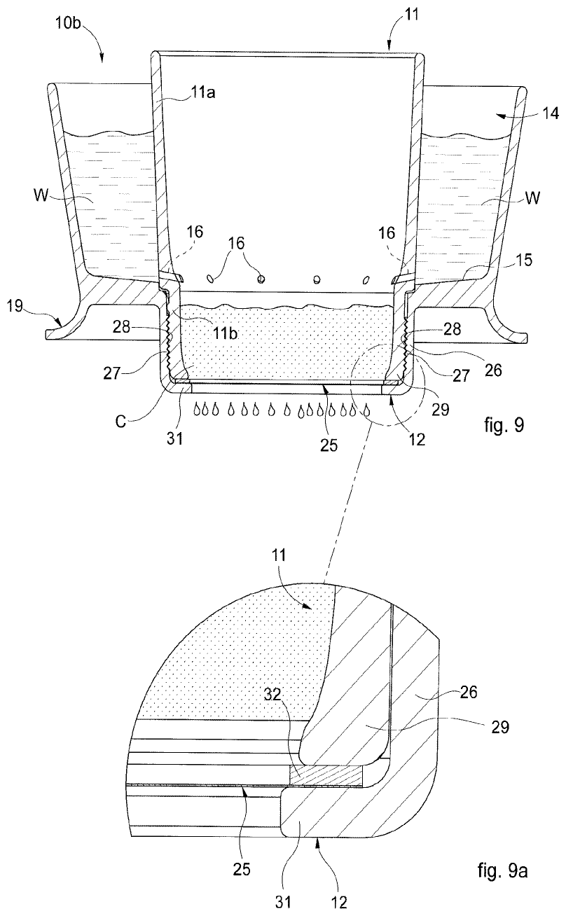

The filter 13 can be made of plastic, metal or other, and comprise a series of through holes 17 of suitable sizes. Alternatively, as shown in FIG. 8 or FIG. 9, a paper filter 25 can be provided.

The filtering device 10 is positioned on a receptacle 18 in which the beverage B extracted by percolation is collected. The receptacle 18 can be of any type whatsoever, for example a cup, a jug or other type known in the state of the art, provided that it is suitably sized with sizes that allow a stable positioning of the filtering device 10 on it.

In the example shown here, the filtering device 10 comprises a flange 19 configured to allow it to rest, during use, on the upper edge of the receptacle 18.

The flange 19 is disposed concentrically around the tubular body 11.

The flange 19 is provided with an annular step 20 configured to allow the filtering device 10 to stably rest on the receptacle 18. Of course, it would also be possible to provide different rest systems, without the flange 19 and the annular step 20.

In other embodiments, not shown, other temporary and removable coupling systems can be provided between the filtering device 10 and the receptacle 18. By way of a non-limiting example, the filtering device can comprise a thread able to allow a screwing of the filtering device 10 on the correlated receptacle 18, which is also provided with a respective thread. Alternatively, a mechanical same-shape coupling with interference, for example of the male-female type, can be provided, in particular with an annular ridge that engages in a corresponding groove.

An annular recess 21 is created between the tubular body 11 and the flange 19. Ribs 22 are positioned in the annular recess 21. The ribs 22 can be useful to allow the filtering device 10 to rest on the receptacle 18, if the flange 19 and the step 20 are not provided. The ribs 22 are also useful because they leave a way out for the water vapor that forms on the beverage B, thus counteracting the formation of condensation. Furthermore, the ribs 22 can have the function of stiffening the filtering device 10.

The chamber 14 where the hot water is poured by the user is annular and disposed around the tubular body 11. In particular, the chamber 14 is disposed around the tubular body 11 without a break in continuity. This allows, for example, the hot water to hit, through the through holes 16, the powder product C at 360°, obtaining an optimal uniformity of contact with and of passage through the powder.

The chamber 14 is disposed concentrically around the tubular body 11, so that it has a uniform width around the tubular body 11.

The chamber 14 preferably has a truncated cone shape, in particular with a section decreasing from an upper aperture 24 toward the bottom 15, so as to guarantee a better distribution of the hot water to the through holes 16.

The tubular body 11 can provide a first part 11a with a truncated cone section, decreasing from a respective upper aperture 23 from which the powder product C is introduced, and a second part 11b with a cylindrical section, which reaches the proximity of the support 12 of the filter 13.

In the example described here, the upper aperture 24 of the chamber 14 and the respective upper aperture 23 of the tubular body 11 are exposed to the surrounding environment so that both the chamber 14 and also the tubular body 11 are open. This avoids creating overpressure that can cause the coffee powder to compact and give the hot water parameters (pressure, speed) that are not suitable to achieve an effective extraction.

The support 12 is integral with the chamber 14 and provides an annular wall 26 in which a thread 27 can be created, configured to engage with a corresponding counter-thread 28 created in the second part 11b. In this way, substantially, the tubular body 11 can be screwed onto and unscrewed from the support 12, and therefore from the chamber 14.

The filtering device 10 can therefore be made, for example, in two parts, that is, the tubular body 11 and the chamber 14 provided with a support 12, on which to screw the tubular body 11. These two parts can be made of plastic or thermoplastic material, such as polypropylene or suchlike, of metallic material, or other.

The bottom 15 of the chamber 14 is inclined downward toward the tubular body 11 and toward the through holes 16, so as to facilitate the passage of water through them and allow an effective emptying of the chamber 14.

The through holes 16 are positioned in proximity to the bottom 15, so as to use all the water poured into the chamber 14.

In order to guarantee a better uniformity in the distribution of the water to the powder product C, the through holes 16 are uniformly distributed on the tubular body 11, therefore at 360° and equally distanced from each other.

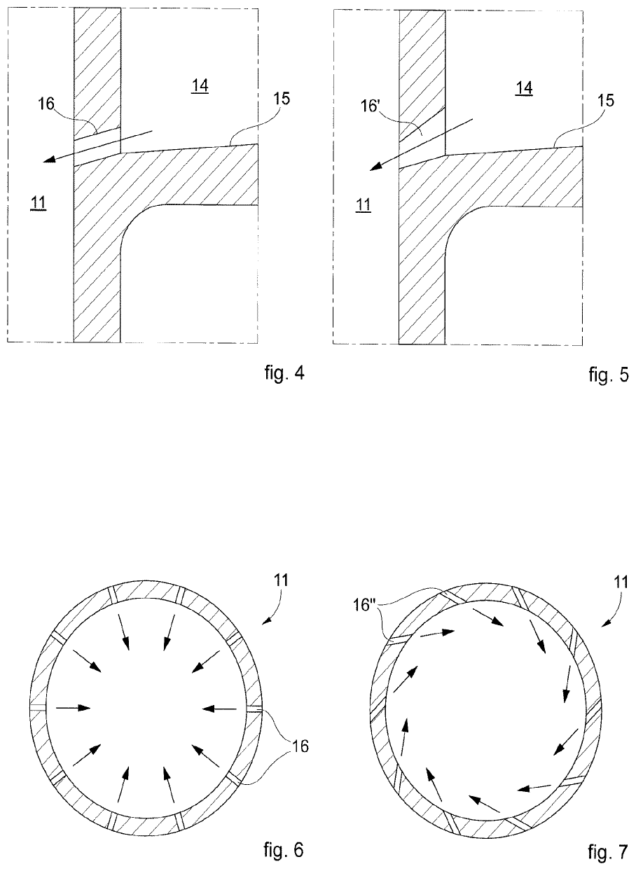

The through holes 16, see for example FIG. 4, can be inclined downward toward the inside of the tubular body 11, or be directed horizontally. In any case, it is preferable that the through holes 16 have a certain inclination to facilitate the outflow of the water.

The through holes 16 can have a cylindrical shape, as in FIG. 4, or a truncated cone shape, see for example the through holes 16′ of FIG. 5. 5. In this case, the through holes 16′ have a larger section on the inlet side of the liquid W and a smaller section on the outlet side.

The through holes 16 or 16′ can be directed radially, as shown by way of example in FIG. 6, or provide a tangential component, please see holes 16″ in FIG. 7. By means of the tangential component a flow is generated that contributes to further increasing the uniformity of contact of the liquid W with the powder product C. In fact, this tangential component can give the flow a vortical component that improves the distribution of the liquid in the powder product C.

In some embodiments of the present invention, the through holes can therefore have a truncated cone shape that gives them a certain inclination to promote the outflow of the liquid, such as for example the holes 16′ of FIG. 5, and they can at the same time have a certain tangential component, such as for example the holes 16″ of FIG. 7, or even only one of such inclinations/components.

FIGS. 8, 8a show a variant of the present filtering device 10a provided with the paper filter 25 which on the bottom is positioned between the end 29 of the tubular body 11 and the support 12. In particular, the end 29 and the support 12 are shaped in such a way as to engage reciprocally and form a labyrinth system 30 for clamping the filter 25 in position, in particular a peripheral part thereof. In particular, the labyrinth system 30 can be provided, at the end 29 and the support 12, with one or more protrusions 33 and one or more recesses 34 able to reciprocally couple when the tubular body 11 is completely screwed into the support 12.

The user, therefore, before screwing the tubular body 11 to the annular wall 26 of the support 12, will position the filter 25 above the annular step 31. He will then screw the tubular body 11 to the support 12, also achieving the clamping in position of the filter 25. At this point, he will be able to pour the desired amount of powder product C onto the filter 25.

FIGS. 9, 9a show another variant of the present filtering device 10b, in which the opposing surfaces of the end 29 and of the support 12 are substantially flat and distanced from each other, and a gasket 32 for clamping the filter 25 is disposed between them. In particular, once the tubular body 11 has been screwed into the support 12, the peripheral part of the filter 25 remains trapped between the gasket 32 and the annular step 31 of the support 12.

The labyrinth system 30 and the gasket 32 are therefore two examples of means for holding the filter 25 in position between the tubular body 11 and the support 12.

The user disposes the filtering device 10, 10a, 10b on the receptacle 18, for example a jug, a cup or suchlike, then pours the desired amount of powder product C onto the filter 13. He then pours the liquid W, in particular hot water, into the chamber 14. The hot water passes through the through holes 16, 16′, 16″ and slowly hits the powder product C and percolates in the receptacle 18, thus allowing to obtain the beverage B.

The embodiments of the filtering device 10a, 10b of FIGS. 8 and 9 also advantageously allow to promote the elimination of the powder product C and of the disposable paper filter 25 after the beverage B has been obtained. In fact, it is sufficient for the user to take the filtering device 10a, 10b above a suitable container for disposal, and unscrew the tubular body 11 from the support 12. In doing so, the filter 25 is no longer held in position by the holding means, and the own weight of the powder product C, which is wet as a result of the extraction of the beverage, is sufficient to cause the filter 25 and the dose of powder product C present thereon to fall by gravity.

We have experimented that by using about 12 gr of powder product C, in particular coffee powder, 300 ml of liquid W, in particular hot water, in a period of time of about 3 min. and 30 s the beverage B is obtained. Furthermore, as mentioned above, advantageously, it is possible by means of the present filtering device 10, 10a, 10b to obtain the same TDS as a traditional filtering system, but using a smaller amount of powder product C.

This period of time is much longer than the short time with which a beverage is obtained by means of traditional filtration systems, with or without cylinder and plunger, therefore the beverage B obtained has much better organoleptic properties than those obtainable by means of such known systems. Moreover, by means of the present filtering device, bypass and channeling phenomena are advantageously avoided, avoiding the formation of preferential passageways of the liquid that in known systems can compromise the uniformity of the extraction and therefore the quality of the beverage. Furthermore, the filtering device 10, 10a, 10b is simple to use and requires fewer manual skills from the user than what is required in known systems.

### Example 1

Table 1 below shows an example of how to use the filtering device 10a, 10b, 10c, with which seven extractions were performed, compared with three extractions using a traditional V60 filtration system.

Looking at the data, it can be seen that with the same recipe and granulometry, therefore with the same surface area available for the extraction, the present filtering device has a higher extraction efficiency than what occurs with a conventional filter, such as the V60.

TABLE 1

| | Filtering device 10a, 10b, 10c | | | | | | | V60 | | |
|---|---|---|---|---|---|---|---|---|---|---|
| Extraction no. | 1 | 2 | 3 | 4 | 5 | 6 | 7 | 1 | 2 | 3 |
| Grinder | 2 | 2 | 2 | 2 | 2 | 2 | 2 | 2 | 2 | 1 |
| setting | | | | | | | | | | |
| Coffee | Ethiopia | Ethiopia | Ethiopia | Ethiopia | Ethiopia | Ethiopia | Ethiopia | Ethiopia | Ethiopia | Ethiopia |
| Coffee | 15 | 15 | 15 | 15 | 15 | 15 | 12 | 15 | 15 | 15 |
| weight [g] | | | | | | | | | | |
| Brewed | 250 | 250 | 250 | 250 | 250 | 300 | 250 | 250 | 250 | 250 |
| coffee [g] | | | | | | | | | | |
| Brewing time | 4′30″ | | | | | 4′ 15″ | 3′ 30″ | 2′ | | 4′ |
| TDS | 1.6 | 1.49 | 1.49 | 1.61 | 1.61 | 1.12 | 1.04 | 1.23 | 1.27 | 142 |
| Extraction | 26.67 | 24.83 | 24.83 | 26.83 | 26.83 | 22.40 | 21.67 | 20.50 | 21.17 | 23.67 |
| Yield % | | | | | | | | | | |

The result shown in table 1 is due in particular to the absence of bypass and channeling phenomena in the present filtering device, that is, the absence of preferential channels for the water that would tend not to extract the coffee (paths with minimal hydraulic resistance). This has been achieved in particular through the separation between the feed chamber 14, the tubular body 11 and the receptacle 18, and the shape of the present filtering device, in which the chamber 14 is annular and disposed around the tubular body 11. The chamber 14 is also fluidically connected to the tubular body 11 by means of the plurality of through holes 16, 16′, 16″ that allow the passage by gravity of the liquid W from the chamber 14 to the tubular body 11, and therefore uniformly to the powder product C.

Moreover, if the through holes 16″ provide a tangential component, as in FIG. 7, it is possible to provide an agitation of the powder product C, thanks to the vorticose motion of the liquid triggered by the disposition of the holes 16″. Agitation in traditional methods depends on the dexterity of the operator and this can lead to the extraction of undesirable substances.

The present filtering device also allows to avoid phenomena of perforation of the powder product C, which when positioned in the filter is normally a compact assembly. Such phenomena could occur with conventional water pouring techniques.

Furthermore, to achieve lower extraction yields with the same granulometry, it is sufficient to simply decrease the dose of coffee or increase the amount of water, that is, change the coffee dose/amount of water ratio.

The same thing cannot be achieved with the traditional filter due to bypass and channeling phenomena. In fact, in case 3 of the V60, the granulometry was changed, making it finer, thus increasing the extraction surface. However, the extraction yield did not increase by much, despite the larger extraction surface and greater amount of time (4 minutes), precisely due to the bypass and channeling phenomena.

By means of the present filtering device, thanks to its geometry, beverages with an ideal extraction yield (17-27%) can be obtained using less coffee or a greater amount of water compared to conventional methods. This translates into savings for the user. See for example extraction no. 7 in table 1.

In addition, the preparation does not require a pouring and preparation technique typical of conventional methods that require trained people and their constant presence throughout the duration of the extraction.

By using the present filtering device this does not happen, and the results achieved are the result of a controlled extraction with times which are suitable to wet all the coffee particles and extract its substances, unlike what happens in conventional filters where the times are shorter, and the presence of bypass and channeling phenomena do not allow to extract the substances from the coffee in an adequate manner.

### Example 2

Further extractions carried out with a different type of coffee and with a coarser grinding (grade 4) are shown below in table 2.

The following data refer to six percolations performed with the present filtering device 10a, 10b, 10c, to demonstrate the repeatability and constancy of the extractions promoted by its geometry. The granulometry, weight and coffee used are the same.

TABLE 2
Filtering device 10a, 10b, 10c

| Extraction no. | 1 | 2 | 3 | 4 | 5 | 6 |
|---|---|---|---|---|---|---|
| Grinder | 4 | 4 | 4 | 4 | 4 | 4 |
| setting | | | | | | |
| Coffee | Brazil | Brazil | Brazil | Brazil | Brazil | Brazil |
| | Santos | Santos | Santos | Santos | Santos | Santos |
| | Cerrado | Cerrado | Cerrado | Cerrado | Cerrado | Cerrado |
| Coffee | 12 | 12 | 12 | 12 | 12 | 12 |
| weight [g] | | | | | | |
| Brewed | 251.3 | 256 | 258 | 251.7 | 254.8 | 250.4 |
| coffee [g] | | | | | | |
| Brewing | 4′07″ | 3′49″ | 3′53″ | 4′16″ | 4′05″ | 4′19″ |
| time | | | | | | |
| TDS | 0.83 | 0.81 | 0.81 | 0.82 | 0.82 | 0.84 |
| Extraction | 17.38 | 17.28 | 17.42 | 17.20 | 17.41 | 17.53 |
| Yield % | | | | | | |

It is clear that modifications and/or additions of parts may be made to the filtering device for the extraction of a beverage as described heretofore, without departing from the field and scope of the present invention, as defined by the claims.

It is also clear that, although the present invention has been described with reference to some specific examples, a person of skill in the art will be able to achieve other equivalent forms of filtering device for the extraction of a beverage, having the characteristics as set forth in the claims and hence all coming within the field of protection defined thereby.

In the following claims, the sole purpose of the references in brackets is to facilitate their reading and they must not be considered as restrictive factors with regard to the field of protection defined by the very claims.

1. A filtering device for the extraction of a beverage, comprising a tubular body and a support for housing a filter on which a powder product is positioned, wherein the filtering device provides a chamber for containing a liquid external to said tubular body, provided with a bottom positioned at a height higher than the height of said filter and fluidically connected to said tubular body by means of a plurality of through holes (16, 16′, 16″) which allow the passage by gravity of said liquid from said chamber to said tubular body and therefore to said powder product, said chamber also being annular and disposed around said tubular body.

2. The filtering device of claim 1, wherein said chamber is disposed concentrically around said tubular body.

3. The filtering device of claim 1, wherein said chamber has a truncated cone shape with a section decreasing from an upper aperture toward said bottom.

4. The filtering device of claim 1, wherein said bottom is inclined downward toward said tubular body and toward said through holes.

5. The filtering device of claim 1, wherein said through holes are uniformly distributed on said tubular body and are directed radially or with a tangential component.

6. The filtering device of claim 1, wherein said through holes are inclined downward toward the inside of said tubular body.

7. The filtering device of claim 1, characterized in that wherein said through holes are positioned in proximity to the bottom of said chamber.

8. The filtering device of claim 1, wherein said through holes are cylindrical in shape.

9. The filtering device of claim 1, wherein said through holes (16′) have a truncated cone shape and a larger section on the inlet side of the liquid and a smaller section on the outlet side.

10. The filtering device of claim 1, wherein said tubular body is able to be screwed to said support integral with said chamber.

11. The filtering device of claim 1, wherein between said tubular body and said support there are positioned means for holding said filter in position.
